(19) United States
(12) Patent Application Publication
(10) Pub. No.: US 2026/0114664 A1
(43) Pub. Date: Apr. 30, 2026

(54) A COOKING APPARATUS WITH CONSTANT AIRFLOW FEATURES

(71) Applicant: HARDT EQUIPMENT MANUFACTURING INC., Lachine (CA)

(72) Inventors: Mikhail Onishchenko, Lachine (CA); Jean-Francis Defoy, Lachine (CA); Andrey Trush, Lachine (CA); David Friedl, Lachine (CA)

(21) Appl. No.: 19/160,281

(22) PCT Filed: Mar. 7, 2025
(86) PCT No.: PCT/IB2025/052460

§ 371 Date: Aug. 27, 2025

Related U.S. Application Data
(60) Provisional application No. 63/564,332, filed on Mar. 12, 2024.

(51) Int. Cl. A47J 37/04; A47J 37/06; F24C 15/16; F24C 15/32

(52) U.S. Cl. CPC A47J 37/047; A47J 37/041; A47J 37/0641; A47J 37/0664; F24C 15/164; F24C 15/325

(57) ABSTRACT

An apparatus for cooking of food is described. The cooking apparatus may include a main body defining an interior cavity with airflow features. The cooking apparatus may include a control assembly located on the main body assembly with a spit removably and rotatably attached to the main body. A cooking apparatus may include multiple fan mounting points at the top end of the interior cavity in communication with the air plenum. A cooking apparatus may include heating elements, wherein, air is circulated by fans located on the inside of the multiple openings, directing the air to the plenum, wherein, the fans spin in different directions, wherein the introduced air circulates around the spit.

This application claims priority as a nationalization of PCT application PCT/IB2025/052460, filed on Mar. 7, 2025, which in turn claimed priority to U.S. Provisional filing Ser. No. 63/564,332, filed on Mar. 12, 2024, presently expired. The contents of each application is hereby incorporated by reference.

### BACKGROUND OF THE INVENTION

### 1. Field of the Invention.

This disclosure generally relates to a cooking apparatus with optimized airflow inside the cooking cavity. For example, in one embodiment, the cooking apparatus is a rotisserie oven with an electric heating element with specific airflow features.

### 2. Background of the Invention.

Cooking apparatuses with convection features are known in the art and provide a convenient way to cook multiple food portions. For example, rotisserie ovens provide a convenient way to cook multiple food items simultaneously and with even cooking performance.

Convection ovens, also referred to as convention ovens, are frequently used in kitchens and in commercial applications. Unlike conventional ovens, which rely on stationary heating elements, convection ovens feature a fan and exhaust system that circulate hot air around the food. This constant hot air circulation ensures even cooking and browning, making the ovens highly efficient for cooking tasks, especially in a commercial environment where consistent results and repeatability are critical considerations. Cooking appliances with convection features can cook food faster and at lower temperatures, saving time and energy. Rotisserie ovens have applied convection features. Commercial applications particularly benefit from the precision convection appliances offer, making them an indispensable tool.

Convection ovens can use various heating sources, such as gas flame or electric heat. However, electric heating elements provide a number of benefits. Electric heating elements provide precise and consistent temperature control. They can be used with accurate thermostats, preventing waste of heat energy. In many instances, electric ovens distribute heat evenly throughout the cooking chamber, ensuring that food cooks uniformly. Electric heating elements result in greater flexibility and versatility of installation as electric ovens do not emit any fumes or gases during operation, which would require venting. In many rural and urban areas, electricity is more readily available than connections to a natural gas distribution network. Electric heating elements pose fewer safety concerns and require fewer safety sensors, increasing the reliability of the appliance. Electric ovens are often easier to clean than gas ovens. They don't have burners or grates that need regular cleaning, simplifying maintenance and saving time, which is especially valuable in a commercial setting.

Regardless of the heating element used in the cooking apparatus, prior art devices all suffer from air circulation issues, resulting in hotspots and cooler areas. Even in a rotisserie oven with a rotating spit, the food will pass over cooler and warmer areas that prevent even cooking.

A need exists in the art for a cooking apparatus that can simplify the cooking of food items with a consistent cooking chamber. The cooking apparatus should produce consistent results and be easy to clean.

### SUMMARY OF INVENTION

An object of the present invention is to provide a device and method for cooking foods in consistent ways that overcome the drawbacks of state-of-the-art solutions.

Another object of the invention is to provide a cooking apparatus with an interior chamber having a consistent temperature. A feature of this invention is that it allows for efficient air circulation within the cooking chamber. A benefit of the invention is that it cooks food consistently and does not waste energy.

Still, another object of the invention is to provide a cooking apparatus that is easy to clean. A feature of the invention is that the apparatus includes a series of fans that move air, but the fans are located away from the food. A benefit of the invention is that the interior cooking chamber will be easily cleaned.

A further object of the invention is to provide a cooking apparatus with a consistent interior cooking temperature. A feature of the invention is that vertical space within the cooking apparatus is carefully designed. A benefit of the invention is that the cooking temperature is carefully managed.

Briefly, the cooking apparatus described herein includes a main body defining an interior chamber and an air plenum; an electric control assembly located on the main body assembly; a spit removably and rotatably attached to the main body; multiple openings at the top end of the interior chamber in communication with the air plenum; heating elements; wherein, the air is introduced by fans located on the inside of the multiple openings, directing the air to the plenum; wherein, the fans spin in different directions; wherein the introduced air circulates around the spit.

### BRIEF DESCRIPTION OF THE DRAWINGS

The invention, together with the above and other objects and advantages, will be best understood from the following detailed description of the preferred embodiment of the invention shown in the accompanying drawings wherein:

FIG. 1 is a cut-away side view of an embodiment of the cooking apparatus.

FIG. 2 is a closeup of the upper portion of the interior cavity showing details of the airflow within the upper portions of the interior cavity.

FIG. 3 is an overview of the exterior of the top portion of the cooking apparatus.

FIG. 4 shows an exploded view of the top portion of the cooking apparatus.

FIG. 5 depicts a detailed view of the placement of the fans.

FIG. 6 depicts additional details of the fan arrangement.

FIGS. 7A and 7B schematically show the airflow and airflow velocity distribution around fans.

FIG. 8 shows an overview of the airflow within the interior cavity of the cooking apparatus.

FIG. 9 shows the resulting air velocity within the interior cavity.

### DETAILED DESCRIPTION OF THE INVENTION

The foregoing summary and the following detailed description of certain embodiments of the present invention will be better understood when read in conjunction with the appended drawings.

As used herein, an element or step recited in the singular and proceeded with the word “a” or “an” should be understood as not excluding plural said elements or steps unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

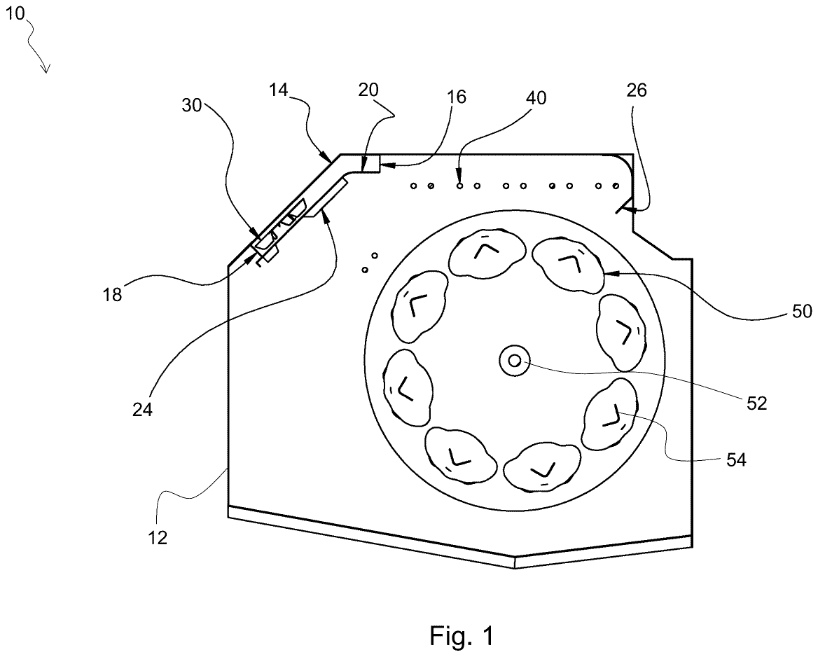

Turning to FIG. 1, depicted therein is a cut-away side view of an embodiment of the cooking apparatus 10. The cooking apparatus includes a main body 12, comprising a regular shape with eight external sides, in the depicted embodiment. The sides comprise panels, including a front panel having doors (not visible in FIG. 1), which allow access to an interior cavity 14. The interior cavity includes a rotating cooking drum 52 with individual spits 54 for food items 50 being cooked in one embodiment. The cooking drum 52 includes wire baskets and other cooking implements in one embodiment. The cooking drum 52 can include rotating spits 54 or fixed skewers where the only rotating element is the cooking drum 52 itself. As described herein, the system is able to provide desirable coloring to the food being cooked (such as chickens) even if fixed skewers are used. The airflow created within the cooking apparatus 10 also creates a consistent coloration to the cooked product, within a single spit or skewer, which allows for multiple chickens to be placed on a single skewer and all of which have uniform cooking results.

Above the cooking drum 52 is an air circulation area, where heating elements 40 are found. The heating elements 40 in FIG. 1 are shown in pairs of electric heating elements, but any number of configurations of heating elements is possible, including electric or gas burner tubes.

To help in the circulation of air, a front baffle 26 rounds out one of the corners of the interior cavity 14, in the depicted embodiment, the front baffle 26 is installed in the corner in the same horizontal plane as the heating elements 40. The front baffle 26 helps direct the heat from the heating elements 40 to the cooking drum 52 and, therefore, the food items 50 inserted on the individual spits 54.

On the opposite end of the line of heating elements 40 is the air circulating area defined by the divider panel 20. The divider panel 20 includes a vertical divider 16 and a horizontal divider 18. A bracket 24 extends from the vertical divider 16 to the horizontal divider 18. The vertical divider 16 includes one or more air handling openings (not visible in FIG. 1). In the part of the interior cavity 14 defined by the bracket 24 at least three fans 30 are located. In some embodiments, the bracket 24 also includes airflow openings in proximity to the fans 30. The details of the fans 30 will be described below in describing the airflow features of the cooking apparatus 10.

The cooking apparatus includes an electric control assembly located on the main body of the cooking apparatus (not shown), which includes a display and the ability to select cooking mode, temperature, and other cooking apparatus settings.

The cooking apparatus 10 main body 12 interior cavity 14 benefits from a uniform airflow towards the main body 12 walls, for example, the roof of the main body 12. The uniform airflow results in uniform heating of the foods being cooked. Standard convection ovens only move air around, resulting in hotspots and cool spots. The arrangement of the cooking features within the main body 12 results in even cooking, which would not accrue simply by adding a convection fan to a standard rotisserie.

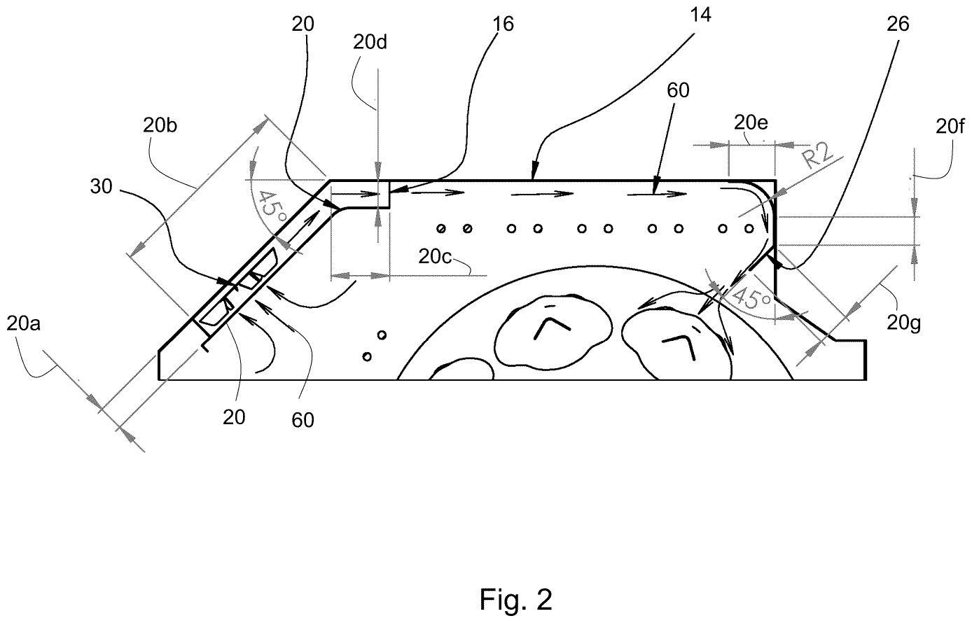

FIG. 2 is a closeup of the upper portion of the interior cavity 14 showing details of the airflow 60 within the upper portions of the interior cavity 14. The airflow 60 circulates from the fans 30 into the divider panel 20 and through the interior of the space defined by the bracket 24, exiting through vertical divider 16, passing over the heating elements 40, and following the shape of the front baffle 26. The airflow 60 then passes over the food items 50.

FIG. 2 shows the measurements of the elements of the cooking apparatus 10 in inches. A benefit of the cooking apparatus 10 is that the air circulation features are very space efficient. The area defined by divider panel 20 is less than 1½ inches tall, in one embodiment being 1⅜ of an inch. This means that the air circulation features require very little space within the interior cavity 14.

FIG. 2 also includes a number of measurements per an embodiment. The air channel width 20a of the enclosure formed by the divider panel 20 is 1⅜ of an inch. The air channel straight segment 20b is 11⅛ of an inch. The air channel output segment has a length 20c of 3⅜ of an inch. The air channel output height 20d is 1½ of an inch. The front baffle 26 first segment 20e is 2⅝ inches. The height 20f of the straight segment of the front baffle 26 is 1⅝ of an inch. The length of the deflector segment 20 g is 2 inches, per the embodiment of FIG. 2.

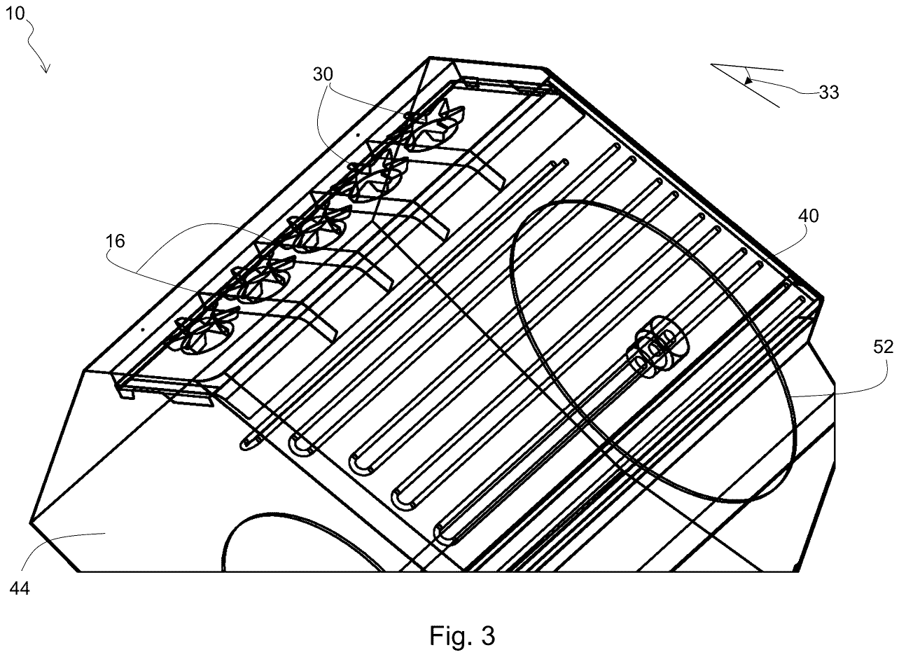

FIG. 3 is an overview of the exterior of the top portion of the cooking apparatus 10, showing the exterior panels 44 depicted as transparent. The cooking drum 52 is attached to one exterior panel 44.

FIG. 3 also shows the shape of each of the heating elements 40, which are shown as a “U” shape in the embodiment depicted in FIG. 3. Also visible in FIG. 3 are the fans 30. The fans are separated by at least one vertical divider 16, which acts as a fan divider. In the embodiment of FIG. 3, there are five fans 30 depicted, although different arrangements are possible. The space between each vertical divider 16 is substantially constant, resulting in fan enclosures with a similar volume of air, except for the fans 30 on the last of the vertical dividers 16. The fans are installed within a divider panel, resulting in particularly advantageous air recirculation. The fans 30 are positioned at an angle 33 with respect to the interior of the cooking apparatus. The angle 33 is shown as an acute angle and results in an optimum stream of hot air recirculating through the food being cooked within the apparatus.

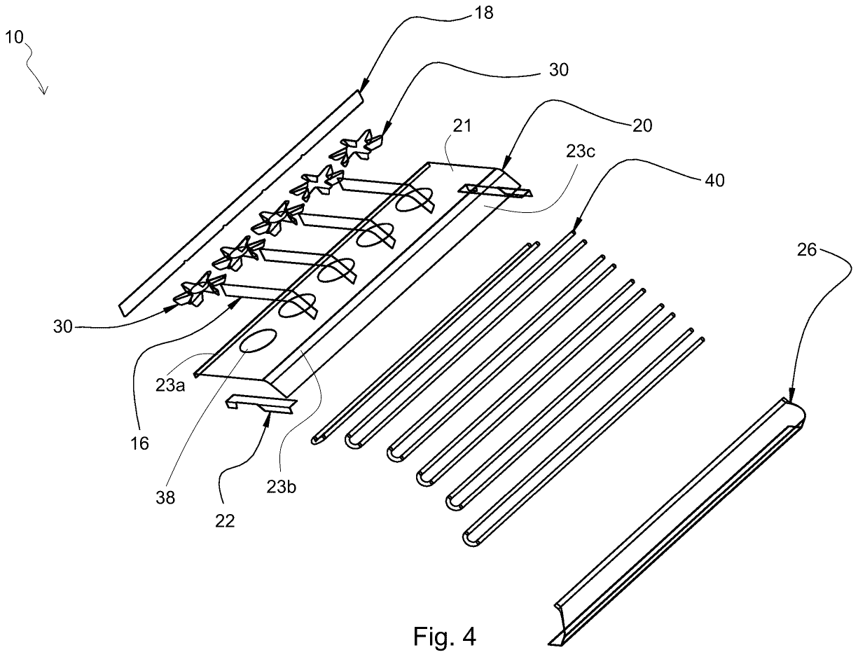

FIG. 4 shows an exploded view of the top portion of the cooking apparatus 10, with the exterior panels removed and not depicted in FIG. 4. FIG. 4 more clearly shows the shapes of the various components. For example, front baffle 26 is shown as a curved metallic element. The heating elements 40 are again depicted as having a “U” shape. The divider panel 20 includes an end bracket 22 at the end of the divider panel 20. The bracket also shows the air openings 38 for the fans 30 and the vertical dividers 16 acting as fan dividers. Also depicted in FIG. 4 is the horizontal divider 18. The combination of elements shown in FIG. 4 is adapted to create a precise air recirculation effect. The air openings 38, with installed fans 30, result in air pressure differences, creating precise air vacuum effects. The elements shown in FIG. 4 create an air duct and carefully direct the air into specific positions in the interior of the cooking apparatus 10. The benefits of the air recirculation are discussed below. FIG. 4 shows the geometry of the divider panel 20, which has a substantially flat portion 21 with the air openings 38 and sidewalls 23a, 23b, and 23c which comprise multiple angled segments. This shape of the divider panel 20 creates the air duct effect to direct the air being recirculated within the interior cavity 14 shown in FIG. 2. As shown in FIG. 2, the air duct formed by the divider panel 20 is approximately 1½ inches tall.

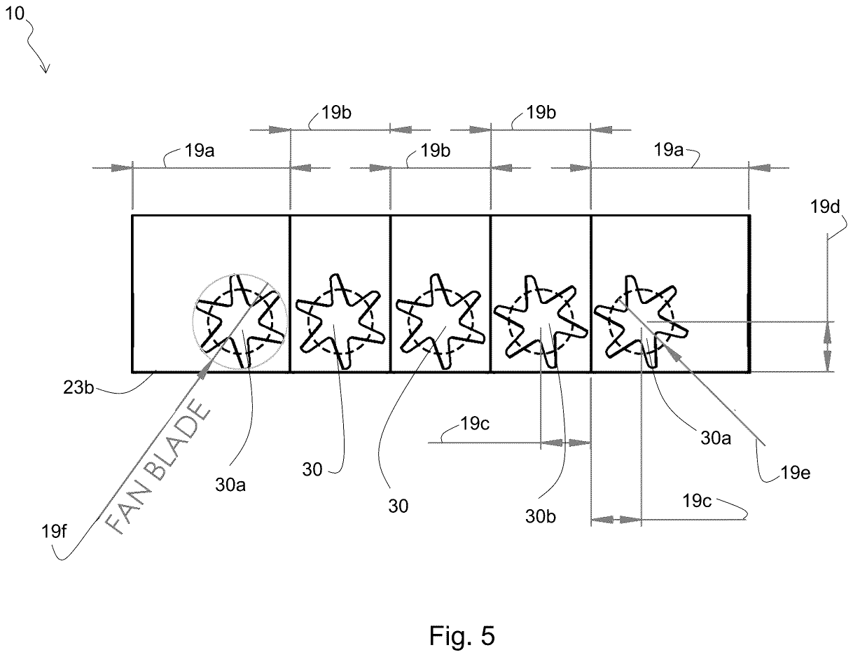

The air circulation details of the cooking apparatus 10 are created by a set of fans 30. A detailed view of the placement of the fans 30 is found in FIG. 5. A benefit of the arrangement of the fans 30 as shown in the embodiment of FIG. 5 is that the fans are individually controllable and replaceable. With multiple fans 30, each fan can turn independently, depending on the heat and load of the cooking apparatus 10. In one embodiment, the fans 30 are mechanically linked, for example, using a set of gears or belts. In another embodiment, the fans are controlled independently by individual motors. In one embodiment, the fans 30 comprise a first set of fans 30a and a second set of fans 30b. The fans do not introduce external air to the cooking chamber. Any exterior air is introduced during the opening of the cooking chamber, such as when cooking is concluded and the cleaning cycle is about to commence.

As shown in FIG. 5, the width of the edge fan enclosure 19a is 9⅞ of an inch. The width of the interior fan enclosure 19b is 6¼ of an inch. The distance from the middle of a fan and the closest wall 19c is 3/18 of an inch. The distance 19d from the middle of the edge fan 30a and the sidewall 23b is 3.13 inches. The diameter of the opening 19e for each fan is 4 inches in the depicted embodiment. The diameter of the extent of the fan blades 19f is 5 and ⅞ of an inch in one embodiment. In this way, the diameter of the opening 19e is smaller than the diameter of the fan blades 19f. This creates a vacuum effect for the airflow being recirculated by the fans 30.

While the fans 30 shown in FIG. 5 (and other figures) are shown as axial fans having six arms, each arm at a different angle, various other types of fans can be used. For example, in one embodiment, at least one fan comprises a tangential fan or a radial fan, which moves air outward in a circular pattern. In one embodiment, the fans are reversible, so the fans can be set to operate in a first or a second direction, as required for optimum airflow. In one embodiment, the fans use different speeds, and at least some of the fans operate at a higher speed, depending on the food being cooked. Each type of fan affects cooking performance, and by having five independently controlled fans, the cooking apparatus can achieve a variety of cooking outcomes.

As can be appreciated from FIG. 4 and other drawings, the fan and divider assembly eliminates the need for a number of complicated housings or coverings for the fans while maintaining separation between the fans, airflow, and food residue. For example, the arrangement shown in FIG. 4 eliminates the need for individual fan housings, such as volute housings for the fan blades, frequently used in cooking apparatuses. There are no additional housings or screens for the fans, as the divider provides both airflow direction and protection for the fans.

The arrangement provides a number of benefits over a traditional convection oven, which includes only one fan. As will be shown in subsequent figures, the airflow is particularly optimized for the shape of the interior chamber of the cooking apparatus 10. If one of the fans 30 slows down, becomes inoperative, or its vent is blocked, the remaining fans 30 will respond accordingly and sustain most of the airflow, something that is not possible with a conventional oven having only one or two fans.

A cooking apparatus 10 with multiple fans results in a number of benefits. For example, multiple fans allow for more control over the cooking process. By adjusting the speed and direction of the fans, the control system of the cooking apparatus 10 creates specific cooking environments suited for various types of food being cooked. In one embodiment, the size of the food being cooked is detected as part of the cooking process, and the speed of the fans 30 is adjusted accordingly. In another embodiment, the amount of moisture leaving the food in the cooking apparatus 10 is measured, and the amount of air exchange is likewise adjusted. Multiple fans 30 ensure a consistent circulation of hot air throughout the cooking apparatus 10. Such even distribution of heat eliminates cold spots, ensuring that food cooks uniformly. Using multiple fans 30 also allows for precise control and response to any detected anomalies, for example, if an oven begins to develop uneven cooking due to wear and tear.

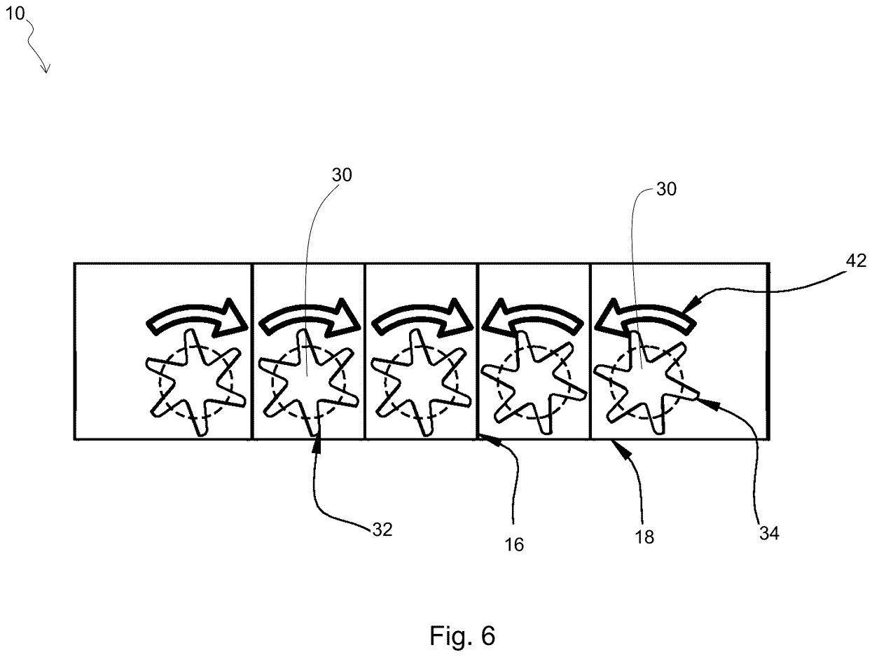

FIG. 6 depicts the direction of rotation for each fan. In the embodiment depicted in FIG. 6, some fans have a left-handed blade 32, while other fans have a right-handed blade 34 arrangement. The blade arrangement refers to the direction of the flat portion of the blade. The direction of rotation 42 for each fan 30 is also shown in FIG. 6. As shown in the figure, some fans turn clockwise while others turn counterclockwise.

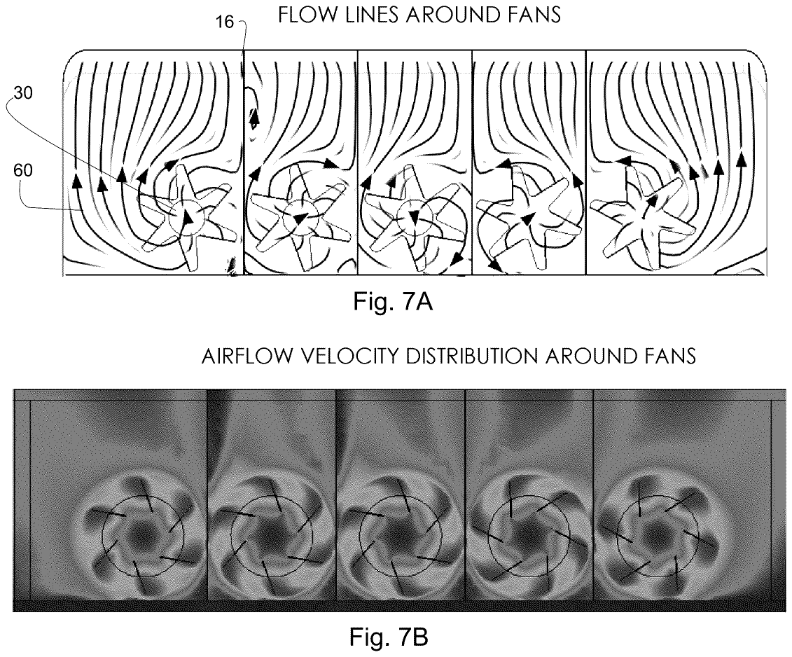

The airflow resulting from the fan arrangement is shown in FIGS. 7A and 7B. FIG. 7A shows the airflow 60 as lines, while FIG. 7B shows the airflow velocity distribution around fans. FIGS. 7A and 7B show the benefits of the combination of multiple fans 30 and vertical dividers 16 limiting airflow. Air is recirculated by at least one of the fans 30. Additional fans 30 operate to re-circulate the air within the interior of the cooking apparatus 10. In one embodiment, the system comprises at least three fans.

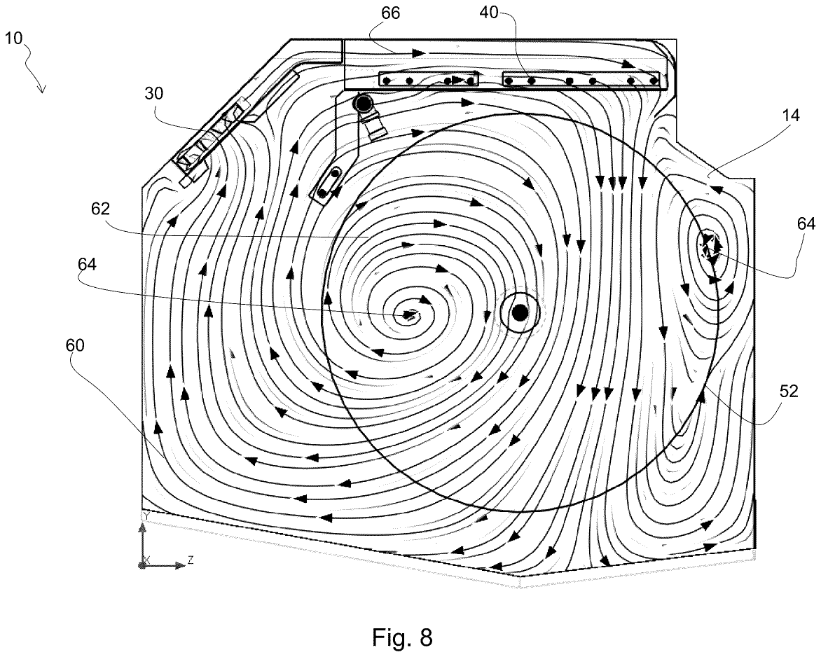

An overview of the airflow 60 within the interior cavity 14 of the cooking apparatus 10 is shown in FIG. 8. This overview shows the air exchange occurring between the fans 30 passing over the heating elements 40 and around the cooking drum 52.

As shown in FIG. 8, the airflow 60 forms a number of 360-degree turns 62 around air pivot points 64. However, the airflow 60 is not limited to a single central circulation point, as would occur in a conventional oven. Instead, the air pivot points 64 are distributed within the interior cavity 14. For example, in the schematic of FIG. 8 there are two such air pivot points 64, neither of which is located in the center of the interior of the interior cavity 14. This distribution of air pivot points 64 results in uniform air velocity within the interior cavity 14. The introduced air and the recirculated air travel around the interior cavity 14.

As the airflow 60 recirculates towards the upper portion of the interior cavity 14, it passes in the area between the heating elements 40 and the top of the interior cavity 14. In the topmost area 66, the air is reheated as it flows and recirculates in the area between the heating elements 40 and the roof. However, the heated air does not linger in the topmost area 66, and is instead recirculated to the interior cavity 14. Therefore, the roof of the cooking apparatus is not heated and experiences a lower temperature than with a conventional cooking arrangement.

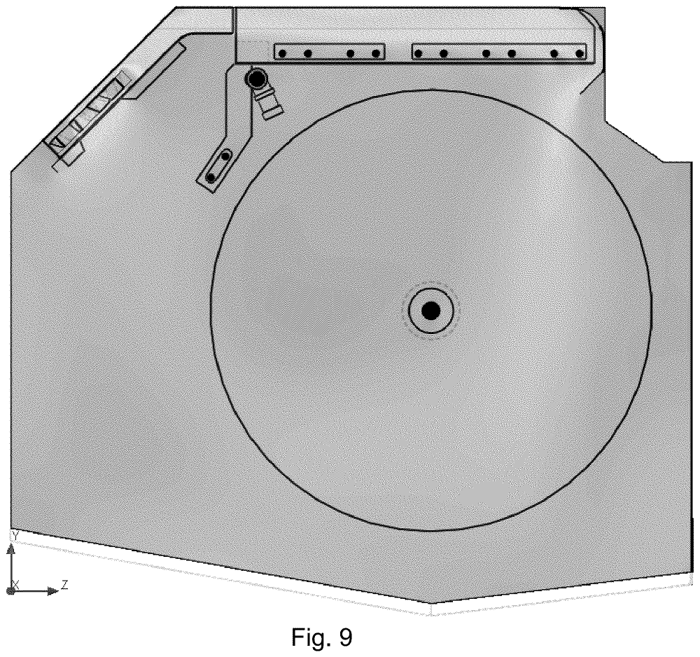

FIG. 9 shows the resulting air velocity within the interior cavity 14. As shown in FIG. 9, the velocity is substantially constant in the cooking part of the interior cavity 14, which provides a number of benefits to the cooking apparatus 10.

Constant velocity in a convection oven confers a number of benefits. Constant velocity ensures an even distribution of heat throughout the oven cavity. This uniform heat distribution eliminates cold spots and hot pockets, resulting in consistent cooking or baking, regardless of the placement of the food items within the oven.

With a constant and steady airflow, a hot air enveloping effect occurs, which leads to faster cooking times as the food is surrounded by consistent heat, cooking it from all sides simultaneously.

Ovens with constant velocity systems are more energy-efficient. Since the heat is evenly distributed and maintained at a constant level, the heating elements do not need to work as hard to achieve the desired cooking temperature, which is particularly beneficial in commercial environments where the ovens are in use for many hours a day.

Constant airflow helps retain the moisture within the food, which is especially beneficial for rotisserie foods, such as chicken. By cooking the food uniformly and quickly, the natural juices and moisture are sealed in, preventing the drying out of the meats. This results in juicier and more flavorful food. The optimum air recirculation ensures that food is cooked in a shorter time than would be possible with conventional ovens.

Constant velocity ensures consistent cooking; the operators can rely on the oven to maintain the desired temperature and cooking conditions. This reduces the need for frequent monitoring, allowing kitchen staff to focus on other tasks without compromising the quality of the cooked food.

As shown in the figures above, the cooking apparatus 10 achieves the benefits of substantially constant velocity within the interior cavity 14 while retaining the benefits of a traditional rotisserie oven. For purposes of this application, substantially constant velocity is velocity that prevents formation of hotspots or cool spots due to slow or non-moving air. The temperature within the cooking apparatus 10 is constant within a range of five percent, in one embodiment. For example, while the cooking apparatus 10 may have multiple fans 30, the increased number of fans does not increase the difficulty of cleaning of the interior cavity 14. The fans 30 are behind the divider panel 20 and are not any harder to clean than a cooking apparatus 10 with a single fan. The capacity of the interior cavity 14 is not impaired by the features responsible for maintaining constant velocity as they have a low profile, as shown in the dimensions shown in FIG. 2. The airflow features of the cooking apparatus 10 are located in areas where food could not be cooked, and so the airflow features do not lower the capacity of the cooking apparatus 10.

The combination of the elements described herein results in a balanced airflow velocity throughout the interior cavity and a constant volume of air from left to right. This provides a uniform convection to the foods being cooked, such as chickens. The beneficial airflow also results in desirable coloration of the chickens, with expected rotisserie-coloration of the skin of the breast, back, and legs of the chickens.

As shown in FIG. 9, the highest velocity is created around the top of the interior of the chamber, with a constant velocity within the chamber. The higher velocity at the top results in the hot air leaving the top area quickly and creates a lower temperature for the top of the chamber roof. This prevents thermal degradation of the exterior panel and creates less danger in the kitchen.

As can be appreciated from the drawings in one embodiment, the cooking apparatus 10 and redirects heated air between the roof and the heating elements 40 recirculating the air and resulting in direct airflow on the food. As described above, the fans 30 rotate in different directions, and fans 30 being placed at an optimum angle with respect to the rotating rotisserie food. In one embodiment, the airflow generated by the fans 30 is provided with an optimum angle by the angled air channels and dividers, as described above and as shown in the drawings.

The optimum air recirculation also allows heating elements to be operated at a lower temperature than is possible for models that lack the unique air handling features. Heat is transferred to the air, moving over the heating elements without the need to operate the heating elements at a high temperature. This results in energy savings, in some cases exceeding 15% compared with conventional ovens lacking the air recirculation features. The air recirculation also ensures that any radiation effects on the heating elements and the food being cooked are balanced and even.

The recirculation features responsible for air transfer during cooking are also helpful during the cleaning cycle of the cooking apparatus. The air system carries the cleaning agent and water during the cleaning cycle, spreading the cleaning agent throughout the interior of the apparatus. This allows for a lower quantity of water and cleaning agent to be used and also extends the life of the interior of the unit.

Several cooking processes, in the form of examples, are described below.

When cooking poultry, such as rotisserie chickens, the apparatus is set to five fans as a default setting. The end user can select a lighter skin coloration, in which case the apparatus is set to use three fans, instead of five. Only three fans will even out the oven temperature, but will reduce direct-convection to the chicken skin, and result in lighter skin coloration.

When cooking vegetables, using one or two fans (instead of five) the cooking apparatus nonetheless will even out the oven temperature but will reduce direct convection to the surface of the vegetables, preventing any burning, resulting in nicer taste, texture, and coloration.

When cooking meat with spices, for example, pork ribs surrounded by dry spices-marinade, using between one and three fans (instead of five), the apparatus will still even out the oven temperature but will reduce direct-convection on the spices, and prevent any burning and bad taste.

When cooking fish with salt, using three or fewer fans (instead of five) the cooking cycle will still even out the oven temperature but will reduce direct convection on the fish skin, therefore getting the expected crispy skin without any burning and an unwanted taste.

When cooking small/light meat products, for example, chicken wings, in one embodiment, the system will start the cooking with one to three fans (instead of five). The cooking is finished with all five fans, which does not overcook the meat and renders crispy skin with highly desirable coloration.

When cooking red meat, for example, thick steak, starting with all five fans will sear the meat surface to keep all the juice/blood inside, and finishing with between one and three fans (instead of five) results in the expected slow cook process.

The use of multiple fans allows the cooking apparatus to be used in place of alternative cooking appliances and optimizes space in a kitchen environment.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

1. A cooking apparatus comprising:
a main body defining an interior cavity with airflow features;
a control assembly located on the main body;
a rotating drum with at least one spit removably and rotatably attached to the main body;
multiple fan locations at a top end of the main body in communication with the interior cavity;
heating elements; and
wherein, air is recirculated by at least three fans located on an interior side of the multiple fan locations, directing the airflow within the interior cavity having airflow features; and
wherein air circulates around the rotating drum with the at least one spit.

2. The cooking apparatus of claim 1 wherein air circulates within the interior cavity at a substantially constant velocity.

3. The cooking apparatus of claim 1 wherein said fans spin in different directions.

4. The cooking apparatus of claim 1, wherein the fans are arranged in a staggered configuration to optimize airflow distribution.

5. The cooking apparatus of claim 1 wherein the interior cavity airflow features comprise at least one vertical divider, at least one horizontal divider, at least one bracket and a front baffle.

6. The cooking apparatus of claim 5 wherein said fans are separated by the at least one horizontal divider.

7. The cooking apparatus of claim 1 wherein fans are actuated independently.

8. The cooking apparatus of claim 1 wherein the airflow features comprise less than 1.5 inches in height to optimize space efficiency of the interior cavity.

9. The cooking apparatus of claim 1 wherein the fans comprise five fans.

10. The cooking apparatus of claim 1, wherein the fans are arranged in separate enclosures to allow for differential control of airflow.

11. The cooking apparatus of claim 1, wherein optimized airflow allows the heating elements to operate at a lower temperature, resulting in energy saving.

12. The cooking apparatus of claim 1, further comprising a display unit operable to select cooking modes and adjusting temperature settings.

13.-24. (canceled)

25. A cooking apparatus comprising:
a main body with an interior cooking chamber;
a plurality of electric heating elements positioned above the cooking chamber;
a plurality of fans configured to circulate air within the cooking chamber; and
an air plenum comprising a divider panel positioned adjacent to the fans, the divider panel defining air openings that direct airflow through the heating elements and over food;
wherein the fans are arranged to create a uniform air velocity within the cooking chamber, minimizing hot and cold spots;
wherein the airflow within the chamber is configured to create at least two distinct air pivot points for balanced circulation.

26.-30. (canceled)
